(19) United States
(12) Patent Application Publication
(10) Pub. No.: US 2006/0008179 A1
(43) Pub. Date: Jan. 12, 2006

(54) Image registration method

(76) Inventors: Bernd Fischer, Buchen (DE); Jan Modersitzki, Lubeck (DE)

Correspondence Address: LARSON AND LARSON, 11199 69TH STREET NORTH, LARGO, FL, 33773, US

(21) Appl. No.: 10/535,682

(22) PCT Filed: Nov. 18, 2003
(86) PCT No.: PCT/DE03/03805

§ 371 Date: Jul. 1, 2005

(30) Foreign Application Priority Data
Nov. 19, 2002 (DE) 102 53 784.4

(51) Int. Cl. G06K 9/32

(52) U.S. Cl. 382/294

(57) ABSTRACT

Disclosed is an image registration method by iteratively determining a transformation that is optimal regarding a given distance criterion and smoothness criterion. Said method allows corresponding landmarks in the images to be definitely represented on top of each other and comprises the following steps: (1) an iteration counter and the initial displacement field are initialized; (2) the numerical solutions of the non-linear partial differential equation (PDE) are determined by means of the differential operator that can be derived from a predefined smoothness criterion and the point evaluation functionals located at given landmarks; (3) the interpoliation conditions are combined; (4) a special numerical solution of the PDE is calculated by means of the force that is determined based on the distance criterion and the actual displacement field as well as the differential operator derived from the smoothness criterion; (5) the special solution is evaluated at the landmarks; (6) the coefficients are calculated in order to calculate an updated displacement; (7) the displacement field is updated and the iteration counter is increased; (8) the displacement is verified regarding convergence; and (9) steps (4) to (8) are repeated if the convergence criterion is not satisfied.

The invention relates to an image registration or recording method, i.e. for the correction of geometrical differences in different representations of an object. These methods play an important part, e.g. in medical technology and particularly when analyzing tissue changes in conjunction with early cancer diagnosis.

Methods are already known which carry out an image registration on the basis of a distance criterion (Lisa Gottesfeld Brown: A survey of image registration techniques, ACM Computing Surveys, 24(4): 325-376, 1992, Jan Modersitzki: Numerical Methods for Image Registration, Habilitation, Institute of Mathematics, University of Lubeck, Germany, 2002). The general methodology is based on the optimization of a target function to be chosen in use-conforming manner and which is typically based on image intensities. In such methods, apart from the image information, no further information is used for registration purposes. The registration result is only of an optimum nature in the sense of a global averaging. If particular significance is attached to specific, characteristic points in an application (such as e.g. the so-called anatomical landmarks in medical applications) such methods cannot be recommended.

Apart from image registration on the basis of a distance criterion, methods are also known which perform image registration exclusively on the basis of control points (Karl Rohr: Landmark-based Image Analysis. Computational Imaging and Vision. Kluwer Academic Publishers, Dordrecht, 2001). In such methods prospectively or retrospectively corresponding control points are associated with the views to be registered and are then matched by means of registration. The disadvantage of such methods is that the registration exclusively takes account of control points. Such methods cannot take account of further image informations, such as e.g. image intensities. In the case of unsatisfactory registration results a user can only attempt to improve them by skilled introduction of further control points. The insertion of further control points is based on subjective trial and error for which no guidelines exist and in particular there is no automated procedure.

The problem of the invention is to develop an image registration method, which leads both to a perfect, guaranteeable correspondence between a number of predetermined control points and also an optimum result in the sense of the distance criterion.

According to the invention this problem is solved by the iterative determination of a transformation optimum with respect to a predetermined distance and smoothness criterion, in which control points corresponding in the images are imaged on one another in guaranteeable manner by (1) initializing an iteration counter and the initial displacement, (2) determining the numerical solutions of the nonlinear, partial differential equation (PDE) with the differential operator derivable from a predetermined smoothness criterion and the point evaluation functionals located at the predetermined control points, (3) combining the interpolation conditions, (4) calculating a specific, numeral solution of the PDE with the force determined on the basis of the distance criterion and the actual displacement field and the differential operator derived from the smoothness criterion, (5) evaluating the specific solution at the control points, (6) determining the coefficient for calculating an updated displacement, (7) updating the displacement field and raising the iteration counter, (8) checking the displacement for convergence and (9) in the case of nonfulfilment of the convergence criterion repetition of steps (4) to (8).

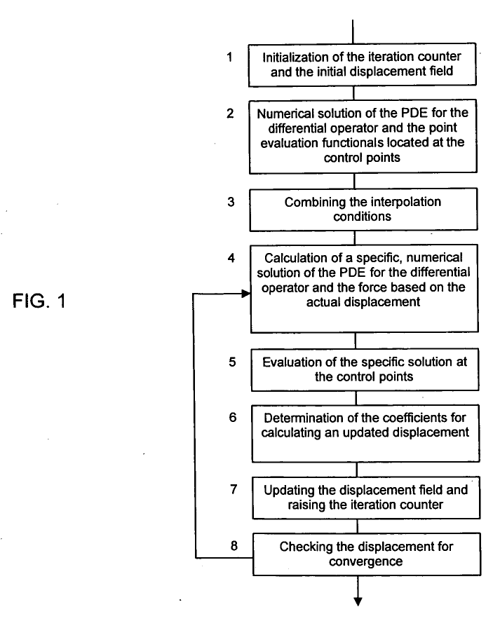

The method sequence is illustrated by the flow chart of FIG. 1.

For simplification purposes a view is referred to as a reference image (reference R) and a further view, which is to be corrected, as a template (template T). From the formal standpoint these are functions of a d-dimensional, real space or a subset Ω⊂R^{d} in the set of real numbers. Thus, to each d-dimensional point xεQ is associated through R(x) and T(x) a value which can be interpreted e.g. as a colour or grey value.

In practical applications, particularly during every programming of the present method, the reference and template can be in discreet form. The images are then functions on a lattice (e.g. Ω={1, . . . , n1}×{1, . . . , n2} for the dimension d=2) in a discreet set (e.g. in the set {0, . . . , 255}) and can be interpreted as being formed from pixels. For the registration method these restrictions and in particular the specific nature of the discretization are unimportant. The restrictions are solely made for simplified description purposes. The method can be used in the same way on random d-dimensional data sets.

The function of image registration consists of the determination of a displacement function u, so that the requirement R(x)=Tu(x) is optimum well fulfilled with the short form Tu(x):=T(x−u(x)) for all xεΩ. For calculating the template Tu deformed by u in the case of discreet, predetermined images such as are of a conventional nature in image processing an interpolation (e.g. d-linear) has to be performed, because the displaced coordinates x−u(x) are not necessarily located on the discreet lattice. The way in which such an interpolation takes place is unimportant for the registration method.

Over and beyond the aforementioned similarity, requirements must be made on the displacement smoothness and on the imaging characteristics with respect to a number of preselected control points. In the simplest case the coordinates of each of the m control points K^{T.j} of the template must be imaged on the in each case corresponding control point k^{R.j} of the reference, j=1, . . . , m. If the coordinates of the control points coincide, which may be ensurable by a preregistration, then u=0 applies at these points.

As is normally the case with optimization problems, the determination of a minimizer of the aforementioned distance criterion can take place iteratively by means of a gradient descent method. In principle, any random distance criterion can be selected. The forces associated with the standard distance criteria are given in the literature (Modersitzki 2002). The specific nature of the calculation of these forces is unimportant for the registration method.

In principle, any functional known from the literature can be used as the smoothness criterion. From the smoothness criterion it is possible to derive a partial differential operator A. These operators are known for the criteria used in the literature (Modersitzki 2002). The sought displacement u can then be characterized as a solution of a nonlinear, partial differential equation (PDE).

For determining a numerical solution of this PDE use is made of a finite differential approximation of the differential operator, which then leads to an equation system for the lattice values of the displacement. However, the specific discretization of the differential equation lacks significance for the registration method.

This procedure coincides with the method based solely on the distance criterion and the smoothness criterion. The new aspect consists of a suitable binding in of the predetermined control points into the displacement calculation, in which a correspondence of the control points can be guaranteed. As methods are already known for the determination of the displacement based on the distance and smoothness criterion, a method is given here which combines partial solutions in an appropriate manner so as to give an overall solution, e.g. in the form

$$ul ( x ) = {v}^{o} l ( x ) + {\sum }_{j = 1}^{m} {λ}_{j}^{l} {v}^{j} l . ( x ) , x ∈ Ω , l = 1 , … , d$$

A is the differential operator associated with the smoothness term and f is the field of forces belonging to the distance criterion, so that v^{o} is a numerical solution of Av^{o}=−f, the functions v^{j} are numerical solutions of the distributional PDE Av^{j}=δ^{j}, j=1, . . . , m, in which δj locates the point selection functional (Dirac impulse) at control point K^{T.j}. The specific, numerical method for the solution of the PDE is unimportant for the registration method.

From the mathematical standpoint v^{j}, j=1, . . . , m are Green's functions of the differential operator A, representing a solution of the PDE at the predetermined single point displacement. A suitable linear combination of these Green's functions consequently ensures that in the overall method, in the required manner, all the control points are imaged on one another.

The function v^{o} is so determined by means of an iterative method that the distance criterion is minimized, whilst maintaining the required smoothness. The weight functions λ^{l}j are so adapted that the control points are imaged in the required way.

The initialization of the program requires the selection of a distance and a smoothness criterion or the force derivable from said criteria and the differential operator. On the basis of the point evaluation functionals located at the control points it is then possible to determine the Green's functions v^{j}, j=1. m with a numerical method. They are not changed during the further course of the method.

The inventive initialization is followed by a standard iteration procedure, during which there is a gradient descent, whilst taking account of the control points. No human intervention is needed. Thus, the described method combines the advantages of methods based on distance criteria (particularly automatability and an on average optimum registration) with those of the control point method (guaranteed registration of distinguished points) and on predetermining an initial set of control points gives reproducible, optimum results, independent of the user or computer program. No important part is played by computer code details in the final result of the image registration and they only influence the requisite computing time and memory requirements.

The images to be registered can be digital images, pixels, JPEG, wavelet-based objects or acoustic signals.

The linear equation systems occurring in the method can be solved directly, indirectly, iteratively or by multigrid and for the method use can be made of a reference coordinate system imaged by Euler or Lagrange coordinates.

The invention also proposes the registration of one, two or three-dimensional and sequences of one, two and three-dimensional objects, as well as the use of control points in the form of anatomical landmarks, fiducial markers or other characteristic quantities.

The distance criterion proposed is based on intensity, edge, corner, surface normal or level set or on the “sum of squared differences”, L2 distance, correlation, correlation variants, mutual information or mutual information variants.

The force terms associated with the distance quantity are to be calculated by finite difference methods or gradient formation and the smoothness criterion used is to be physically motivated by means of an elastic potential or a fluid approach or diffusive or curvature approaches based on time or space derivatives of the displacement.

The boundary conditions of the differential operator are advantageously given by explicit or implicit, Neumann, Dirichlet, sliding, bending or periodic boundary conditions.

The nature of the discretization of the differential operator should be based on finite differences, finite volume, finite elements, Fourier methods, series expansions, filter techniques, collocations or multigrid and interpolation is to be performed d-dimensionally by means of splines or wavelets.

Finally, displacement can be explicitly updated by means of the increment of the displacement or its time derivative.

1. Method for the registration of images by iterative determination of an optimum transformation with respect to a predetermined distance and smoothness criterion, characterized in that control points corresponding in the images can be imaged on one another in guaranteeable manner, by
(1) initialization of an iteration counter and the initial displacement field,
(2) determining the numeral solutions of the nonlinear, partial differential equation (PDE) with the differential operator derivable from a predetermined smoothness criterion and the point evaluation functionals located at the predetermined control points,
(3) combining the interpolation conditions,
(4) calculating a specific, numerical solution of the PDE with the force determined on the basis of the distance criterion and the actual displacement field and the differential operator derived from the smoothness criterion,
(5) evaluating the specific solution at the control points,
(6) determining the coefficients for calculating an updated displacement,
(7) updating the displacement field and raising the iteration counter,
(8) checking the displacement for convergence and
(9) in the case of nonfulfilment of the convergence criterion, repetition of steps (4) to (8).

2. Method according to claim 1, characterized in that one, two or three-dimensional objects, as well as sequences of one, two and three-dimensional objects are registered.

3. Method according to one of the preceding claims, characterized in that the control points are anatomical landmarks, fiducial markers or other characteristic quantities.

4. Method according to one of the preceding claims, characterized in that the distance criterion is based on intensity, edge, corner, surface normal or level set or on the sum of square differences, L2 distance, correlation, correlation variants, mutual information or mutual information variants.

5. Method according to one of the preceding claims, characterized in that the force terms associated with the distance quantity are calculated by means of finite difference methods or gradient formation.

6. Method according to one of the preceding claims, characterized in that the smoothness criterion used is physically motivated by means of an elastic potential or a fluid approach or on diffusive or curvature approaches based on time or space derivatives.

7. Method according to one of the preceding claims, characterized in that the boundary conditions of the differential operator are explicit or implicit, Neumann, Dirichlet, sliding, bending or periodic boundary conditions.

8. Method according to one of the preceding claims, characterized in that the nature of the discretization of the differential operator is based on finite differences, finite volume, finite elements, Fourier methods, series expansions, filter techniques, collocations or multigrid.

9. Method according to one of the preceding claims, characterized in that the interpolation is performed d-dimensionally by means of splines or wavelets.

10. Method according to one of the preceding claims, characterized in that the displacement is explicitly updated by means of the increment of the displacement or its time derivative.
